(19) United States
(12) Patent Application Publication
(10) Pub. No.: US 2005/0108685 A1
(43) Pub. Date: May 19, 2005

(54) Software development code management tool

(76) Inventor: Jim C. Ta, Apex, NC (US)

Correspondence Address: Stephen R. Loe;The Law Office of Stephen R. Loe, P.O. Box 649, Frisco, TX, 75034, US

(21) Appl. No.: 10/715,061

(22) Filed: Nov. 17, 2003

(51) Int. Cl. G06F 9/44

(52) U.S. Cl. 717/120; 717/102

(57) ABSTRACT

A method, system, and computer program product for controlling code in a multi-developer software development environment is provided. In one embodiment the software development tool identifies a plurality of software components as non-modifiable and prevents unauthorized access and modification to the non-modifiable objects. When a request from a requesting user to modify one of the software components is received by the development tool, the tool determines whether the software component has been checked out by another user and, if not, provides the requesting user with a modifiable copy of the one of the software. If the software component has been checked out by another user, the requesting user is presented with information as to who has checked out the software component and may send a message to that person if the requesting user so desires. When the user that has checked out the software component finishes, the component is saved and checked back in to indicate that others may now check out the software component to modify it.

### BACKGROUND OF THE INVENTION

1. Technical Field

The present invention relates generally to computer software and, more particularly, to.

2. Description of Related Art

Software complexity has grown over the past few decades to an extent such that developing software applications now often involve hundreds of developers rather than merely one or two. The complexity in programming of this software has often resulted in software that is much easier for an end user to utilize. However, the large number of software developers required to create these software applications creates new problems in development. For example, with an enormous number of developers producing and testing in a software product, it becomes impossible for developers to accurately test the product and debug errors. Thus, the quality of each release is sometimes low. If released to the consumer, this results in dissatisfaction among customers which may result in lower sales and lost profits. Furthermore, at the very least, it results in increase cost in development because of increase time necessary to insure that the software product works properly.

Because there different people may be working on the same subcomponent of a software application, there was the possibility that one developer would overwrite the work of another developer. For example, one developer may improve code in a certain portion of a subcomponent while simultaneously, another developer working with the same initial version of the subcomponent may improve code in a different portion of the subcomponent unaware of the work being done by the first developer. The first developer may finish his work and save the subcomponent. However, the second developer may subsequently finish his work and save his version over the previous version, thus only one of the developers work has been saved and incorporated into the product. Therefore, the first developer may have to perform his work again or the product may be released to the public without anyone aware that the improvement made by the first developer has been lost.

In the prior art, in an attempt to control the code to prevent overwriting someone else's code, a spreadsheet was created to assist the developers. Prior to changing an object, the developer was required to view the spreadsheet to make sure that no one else was working on that object. If no one was working on it, then the developer could check it out by editing the spreadsheet to indicate his or her intent to use that object. This spreadsheet failed to control the source code because it did not prevent other developers from going into the checked out source code and making changes to it while another developer was trying to test it because it relied on each individual developer to follow the procedure, which, for example, was easy for a developer to forget when under stress or time constraints.

Therefore, there is a need for an improved method for controlling the source code in software development to ensure that work is not lost and to increase or maximize the quality of the finished software product.

### SUMMARY OF THE INVENTION

The present invention provides a method, system, and computer program product for controlling code in a multi-developer software development environment. In one embodiment the software development tool identifies a plurality of software components as non-modifiable and prevents unauthorized access and modification to the non-modifiable objects. When a request from a requesting user to modify one of the software components is received by the development tool, the tool determines whether the software component has been checked out by another user and, if not, provides the requesting user with a modifiable copy of the one of the software. If the software component has been checked out by another user, the requesting user is presented with information as to who has checked out the software component and may send a message to that person if the requesting user so desires. When the user that has checked out the software component finishes, the component is saved and checked back in to indicate that others may now check out the software component to modify it.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server in accordance with the present invention;

FIG. 3 depicts a block diagram of a data processing system in which the present invention may be implemented;

FIGS. 4A-4C depict process flow and program function diagrams illustrating checking an object in, checking an object out, and requesting an object in a coordinated programming environment in accordance with one embodiment of the present invention; and

FIGS. 6-11 depict exemplary screen shots presented to a user.

### DETAILED DESCRIPTION OF THE PREFERRED EMBODIMENT

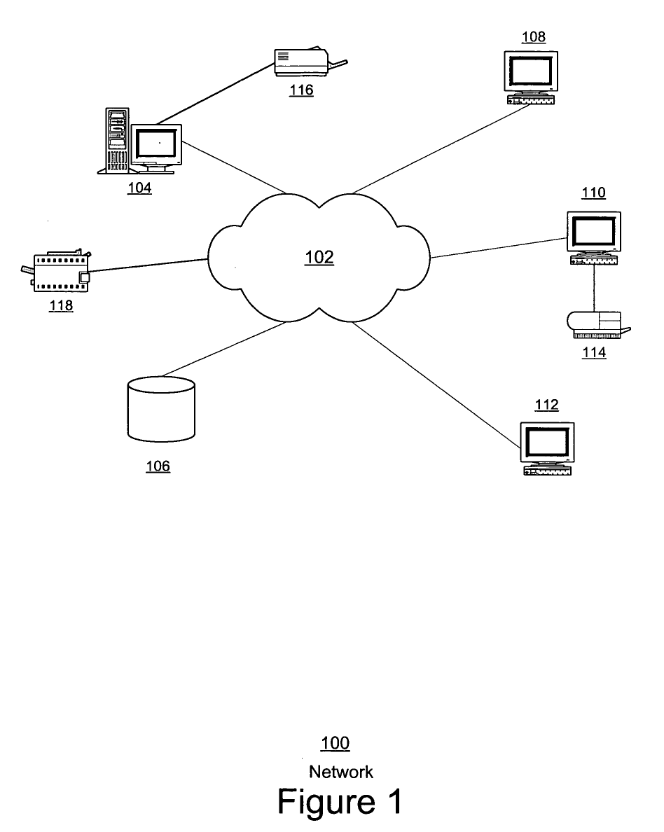

With reference now to the figures, and in particular with reference to FIG. 1, a pictorial representation of a distributed data processing system is depicted in which the present invention may be implemented.

Distributed data processing system 100 is a network of computers in which software developers may work together to develop software. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106, which may be utilized to store the code for the various components of a software product under development. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 may provide data, such as boot files, operating system images and applications, to clients 108-112. However, more importantly, server 104 may provides a system in which software components or objects of the software product under development are checked out by individual developers. Individual developers working at clients 108-112, may access the object check out system on server 104 and check out an object or component code from database 106. Once checked out, the particular software object or component is unavailable for editing by another developer. Once the developer who has checked out a component has finished editing the object or component, the developer checks the object or component back into the system through server 104 which then saves the new version of the object or component in database 106 and makes the object or component available to other developers. Thus, no two developers may have access to the same component at the same time, thereby preventing the work of one of the developers from being lost.

Clients 108, 110 and 112 are clients to server 104 from which, as stated above, various software developers may work and access the various software components and objects under development. Distributed data processing system 100 may include additional servers, clients, and other devices not shown. Distributed data processing system 100 also includes printers 114, 116 and 118 to enable the software developers to print out various files, code, or paper in order to aid their work. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is an Intranet, with network 102 representing an enterprise collection of networks and gateways. However, in order embodiments, distributed data processing system 100 may be the Internet, with network 102 representing a worldwide collection of networks and gateways that use, for example, the TCP/IP suite of protocols to communicate with one another with appropriate security devices such as encryption or the implementation of a Virtual Private Network (VPN) utilized in order to protect the secrecy and integrity of the software developers work. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, a local area network.

FIG. 1 is intended as an example and not as an architectural limitation for the processes of the present invention.

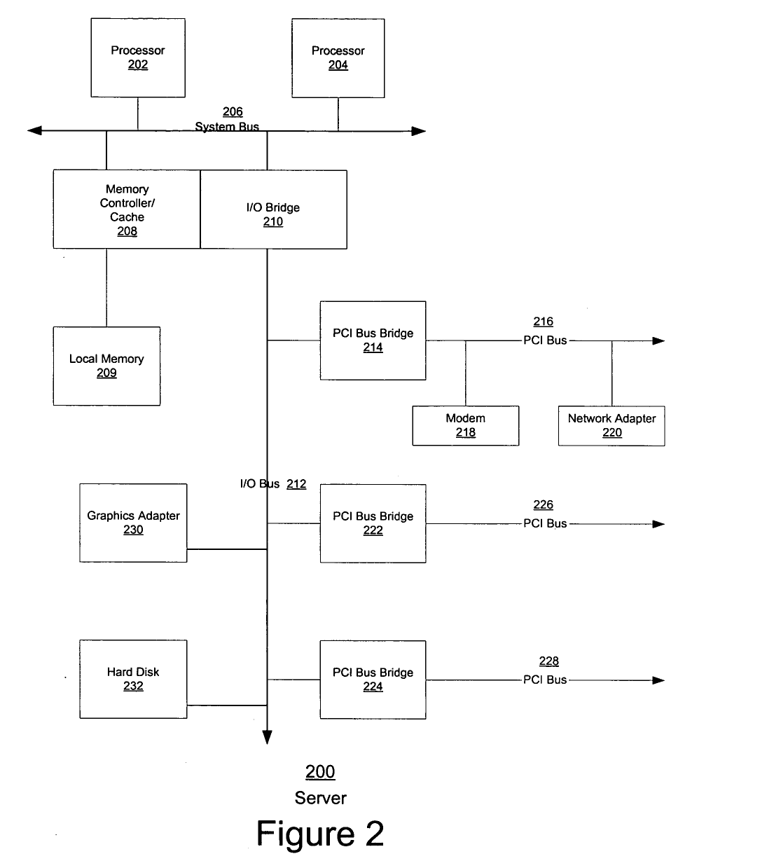

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

An object check out/check in system is implemented on the server to prevent multiple developers from simultaneously working on an object or component of a software product under development, thereby preventing the one developer from overwriting the work of another developer. This system is described in more detail below.

Data processing system 200 may be implemented as, for example, an AlphaServer GS1280 running a UNIX® operating system. AlphaServer GS1280 is a product of Hewlett-Packard Company of Palo Alto, Calif. “AlphaServer” is a trademark of Hewlett-Packard Company. “UNIX” is a registered trademark of The Open Group in the United States and other countries

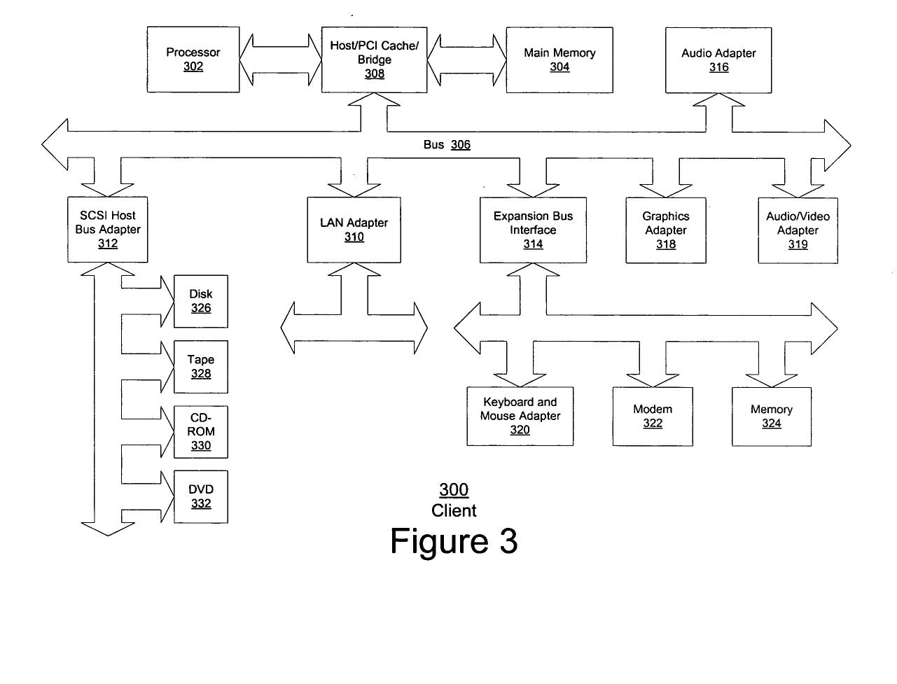

With reference now to FIG. 3, a block diagram of a data processing system in which the present invention may be implemented is illustrated. Data processing system 300 is an example of a client computer which may be utilized by a software developer to check out objects or components from database 106 through server 104 and to modify the code for these objects or components. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation of Redmond, Wash. “Windows XP” is a trademark of Microsoft Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

Before continuing, it will be useful to describe what an object is in object oriented computer programming and how it is useful. Briefly, an object is a software bundle of variables and related methods. Objects in computer programming are similar to real life objects like cars, dogs, etc. Real life objects have two features: state and behavior. For example, dogs have states like color, breed, size, hungry, angry, etc. Dogs also have behaviors like barking, eating, playing, etc. Similarly, objects have states and behaviors, where their states are represented by variables and their behaviors by methods.

One can use software objects to model real life objects like cars or dogs as well as modeling abstract concepts. For example, an event is a common software concept used in graphical user interfaces, such as, for example, MS Windows®, to represent the action of a user pressing a button on a mouse.

One of the many benefits of object oriented programming is its modularity. A piece of software, such as a computer game, is composed of several objects, each representing a different object or abstract concept. Each object can be manipulated and changed independent of the other objects within the total piece of software. For example, if there is a computer game which has an animated dog as one of its characters and also has an animated bicycle as another feature of the game, the dog and the bicycle are represented by different objects. Therefore, if the programmer decides that it would be better to change the dogs color from black to brown, the programmer merely has to change the code associated with the dog's object. Thus, object oriented programming results in software that is, among other things, easier to modify.

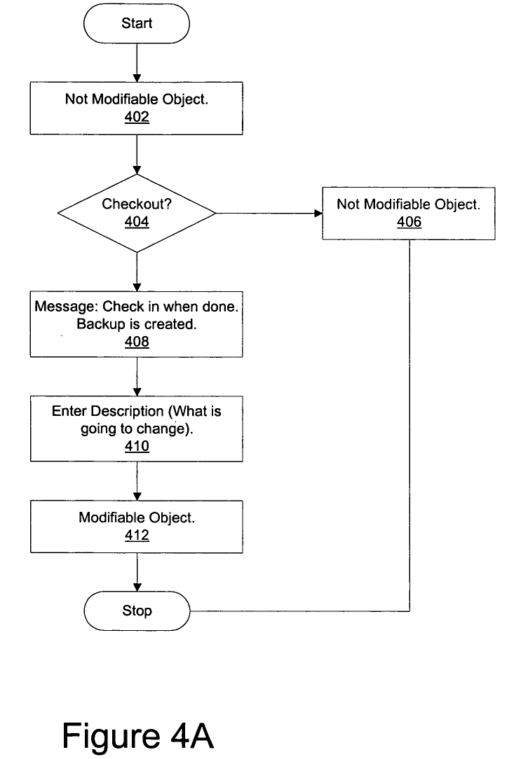

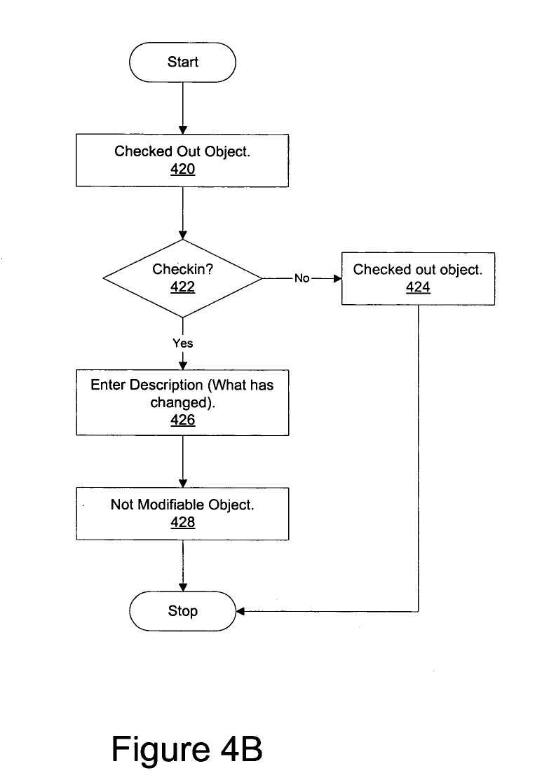

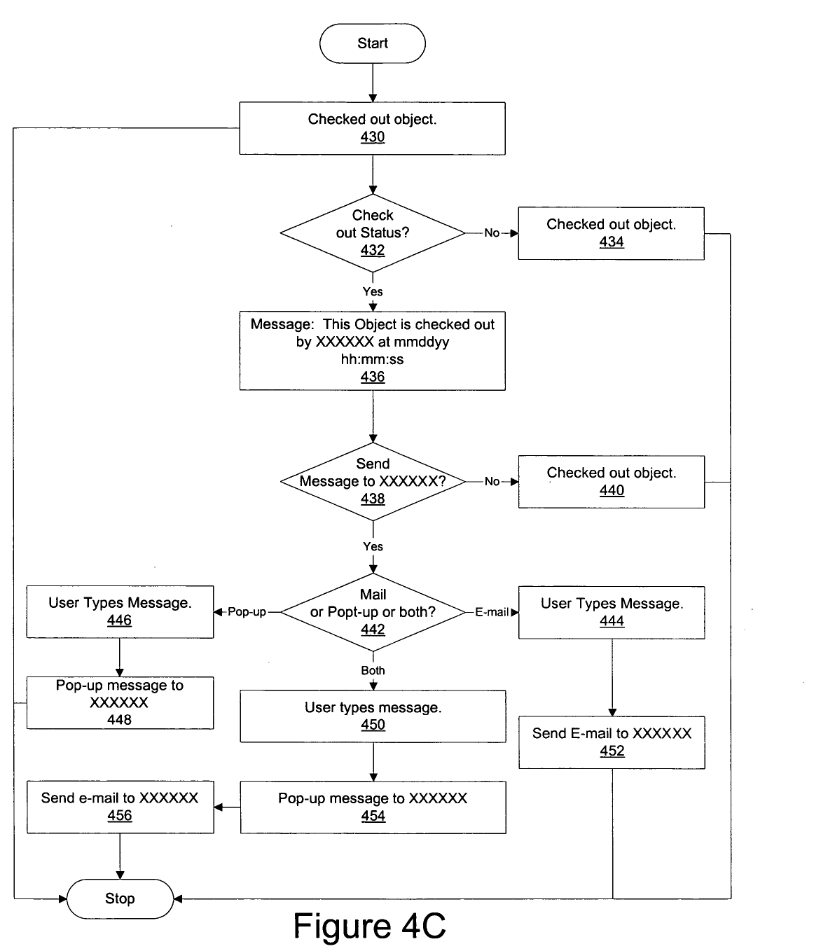

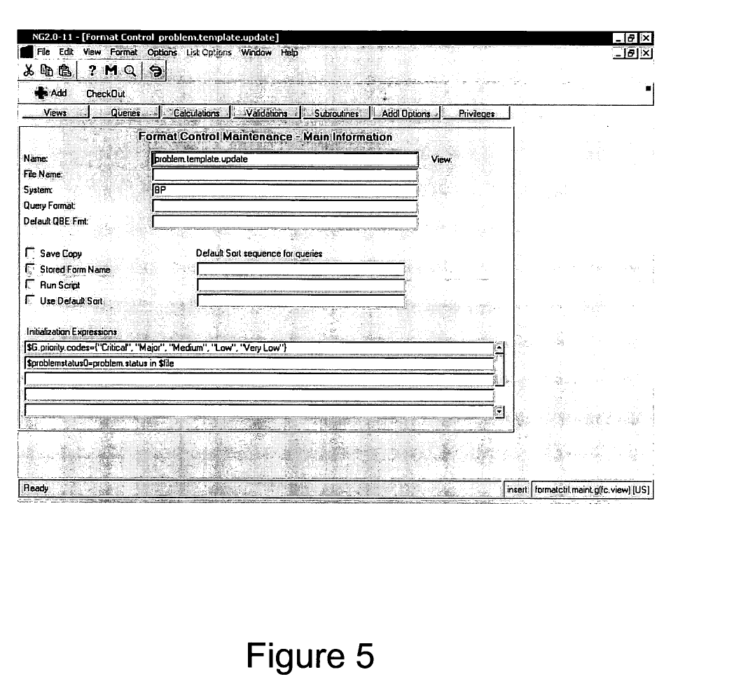

However, as mentioned above, many software programs are very large and have a large number of people, thus, with reference now to FIGS. 4A-4C, program functions and process flows illustrating a system for checking out and checking in objects to prevent overwriting of code by one developer of another is depicted in accordance with one embodiment of the present invention. First with reference to FIG. 4A, a process flow for allowing a software developer to attempt to check out an object in order to modify the object is depicted in accordance with the present invention. To begin, a developer requests an object to modify. For example, the user may be initially presented with a user interface 500 such as depicted in FIG. 5 in which the user must select the “check out” button 502 in order to check out the object or software component. Prior to being checked out, the object is initially tagged as a not modifiable object (step 402). The system determines whether the object is presently checked out by another developer by, for example, checking a table that is kept and updated by the check out/check in system (step 404). If the object requested by the developer is currently checked out by another developer, then the object remains a not modifiable object for the currently requesting developer (step 406) and a message indicating that the object is not currently available for check out is presented to the requesting developer. In various embodiments, the message may also indicate the identity of the developer that currently has checked out the object, the time the object was checked out, and possibly a description of the work being performed on the object.

If the object is not currently checked out, then a backup of the object is created and a message presented to the requesting developer to check in when finished modifying the object (step 408). The backup is automatically created for the user with the user's login ID, along with the date and time appended to the original name of the object. If the user messes up the original source code and cannot back track all the changes that were made, the user can delete it and rename the backup to its original name (i.e., the name of the object without the user's login ID, date, and time appended). An exemplary screen 1100 displayed to the user showing both the modifiable object name 1102 and the backup copy 1104 is depicted in FIG. 12.

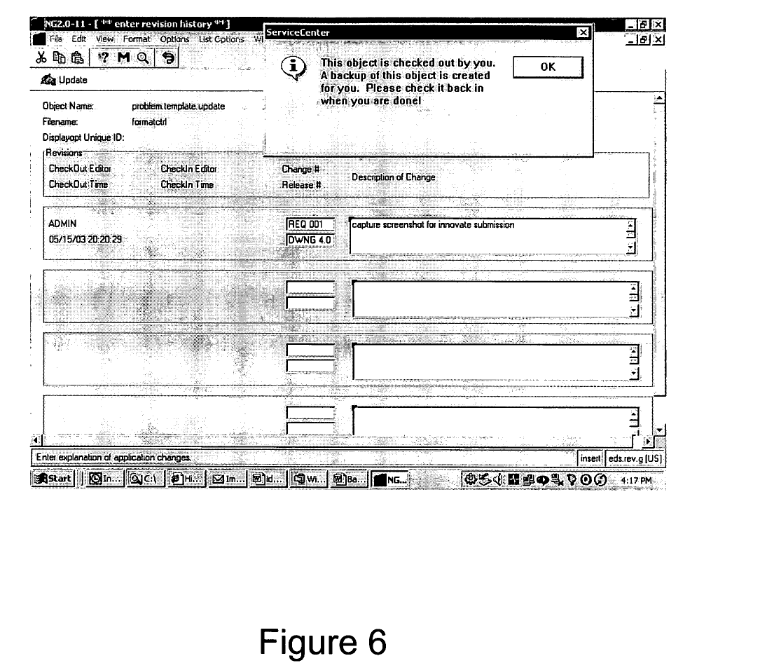

The system also requests that the developer enter a description of what is intended to be changed in the object (step 410) and the object is provided to the requesting developer as a modifiable object (step 412). For example, the software developer requesting the object may be presented with a pop-up screen 602 as depicted in FIG. 6 indicating that the object is checked out by the developer, a backup was created, and requesting that the developer check the object back in when finished. The system then updates its table indicating which developer has checked out the object, when the object was checked out, and indicates the changes that the developer intends to make. The system also marks the object as not modifiable by any other developer.

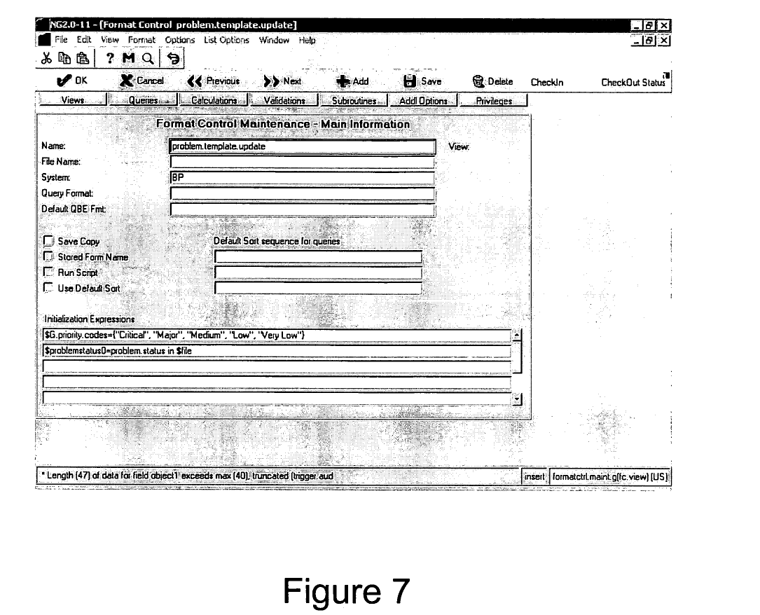

Turning now to FIG. 4B, once the developer has finished modifying the object, the developer may check the object in. For example, once the object is checked out, a screen, such as, for example, screen 700, presented to a user as depicted in FIG. 7 may now include a “save” button 702 allowing the user to now save changes to the object or software component. The user also has a “check in” button 704 available allowing the user to initiate checking the object or software component back in by selecting the “check-in” button 704.

The system therefore monitors checked out objects and communications from developers' client data processing systems (step 420) to determine whether a developer is attempting to check in a checked out object (step 422). If not, the object remains checked out (step 424). However, if an object is being checked in, the system prompts the developer to enter a description of what has changed in the object (step 426) and saves the updated object as a not modifiable object in the database (step 428). The object is now available to be checked out by another developer but is not modifiable until such time as it has been checked out by another developer.

With reference now to FIG. 4C, a process flow and program function illustrating an exemplary method for allowing a software developer to check on the status of an object that has been checked out by another developer. The developer who does not have an object or software component checked out may be presented with a screen such as, for example, screen 500 in FIG. 5. This screen allows the developer to add an object by selecting the “add” button 504 or to check out an existing object or software component by selecting the “check out” button 502. To begin, the system receives a request for an object from a software developer (step 430). The system then checks the status of the object to determine whether the object has been checked out by another developer (step 432). If the object is not checked out, then the developer is presented with a message indicating that the object is available to be checked out (step 434) and the developer may check out the object by proceeding with the process as described above with reference to FIG. 4A.

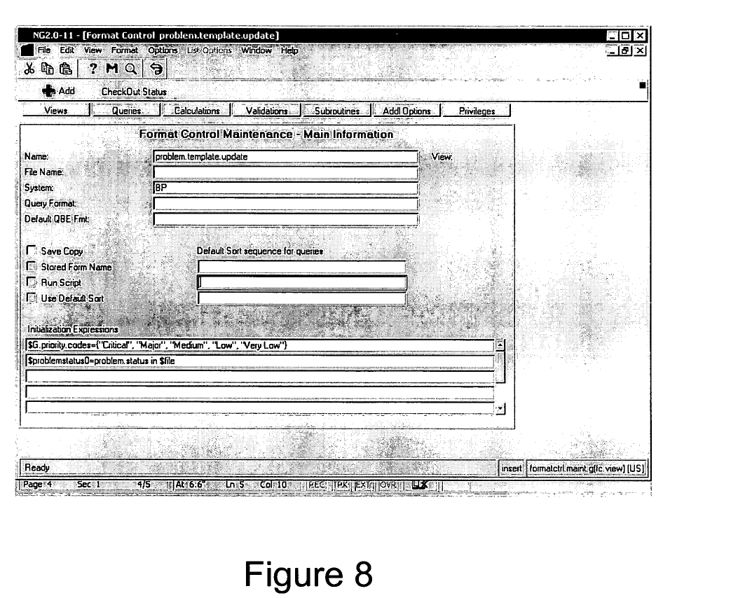

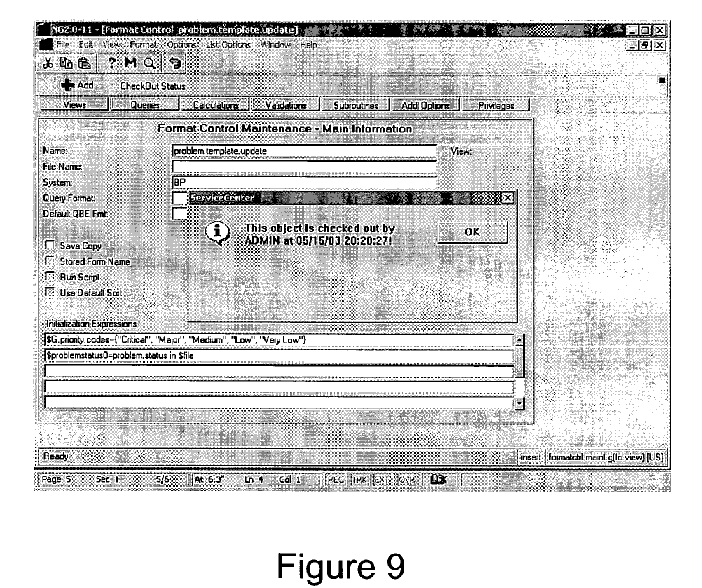

If the object is checked out, then the requesting developer is presented with a message indicating that the object is checked out and allowing the user to check out the status of the object to obtain, for example, the identity of the individual who has checked out the object, and the date and time at which the object was checked out (step 436). An exemplary screen 800 allowing the user to check out the status of the object or software component is depicted in FIG. 8. To check out the status of the checked out object or software component, the user selects the “check out status” button 802. If selected, then the system may display a pop-up message 902 such as depicted in FIG. 9 indicating the identity of the individual who has checked out the object or software component as well as the date and time.

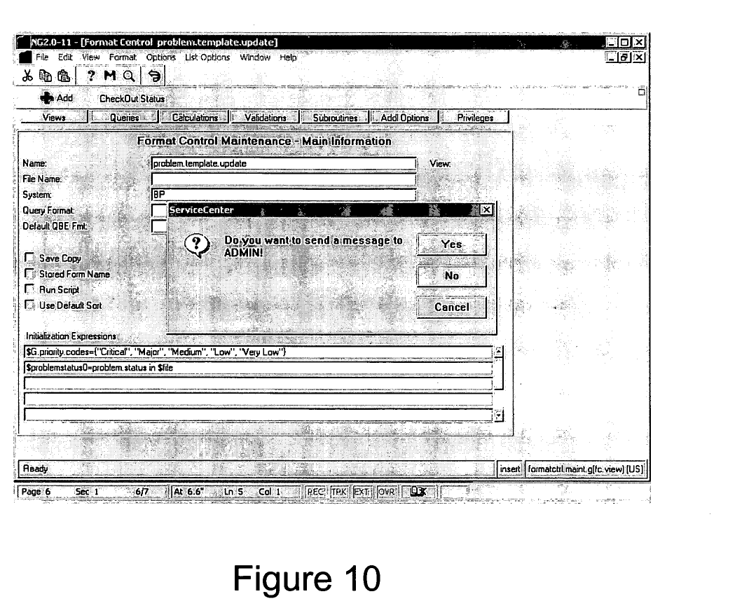

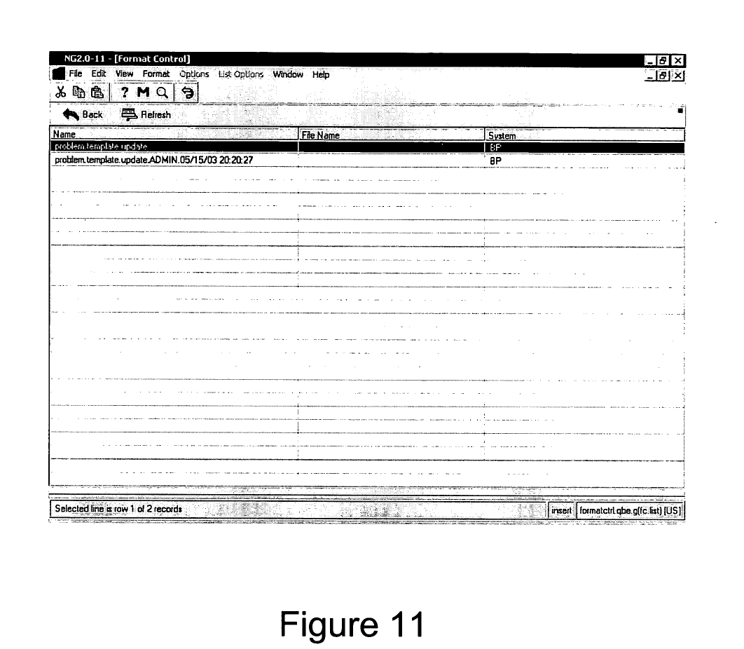

The requesting developer is then presented with an option to send a message to the individual that currently has the object checked out indicating that another developer would like to check out the object (step 438). An exemplary pop-up screen 1002 for allowing the user to make this decision is depicted in FIG. 10. If the requesting developer declines to send a message to the individual that currently has the object checked out, then the object remains checked out (step 440).

If, however, the requesting developer chooses to send a message to the individual who currently has the object checked out, then the system determines whether the requesting developer wishes to send an e-mail message, a pop-up message, or both to the individual who has the object checked out (step 442). If the requesting developer chooses an e-mail, the requester types or otherwise indicates the message to be sent to the individual who currently has the object checked out (step 444) and then the system e-mails the message to the individual who currently has the object checked out (step 452). If the requester chooses to send a pop-up message, the requester again types or otherwise indicates the message to be sent to the individual who currently has the object checked out (step 446) and then a pop-up message is presented to the individual currently having the object checked out (step 448). If the requester selects to have both a pop-up and an e-mail message sent to the individual currently having the object checked out, the requestor types or otherwise indicates the message to send to the individual that has the object checked out (step 450) and a pop-up message (step 454) and an e-mail message (step 456) are both sent to the individual who currently has the object checked out.

Advantages of this system or software development tool are numerous. The tool forces the developers to check out an object prior to making changes. Without checking out the object, developers are not able to make changes. Once the developer checks out the object, a backup is stored in the system. The tool logs the time the developer checked out and checked in the object, the person checking it out and checking it in, the release, and any comments or purpose(s). If a developer wants to work with an object that is checked out by another developer, he or she can view it to see who has the object checked out. An email or a pop-up screen or both can be sent to the checked out developer requesting that the object to be checked back in. If the checked out developer is not in the office, in some embodiments, the Administrator has the access rights to check in the object so that the other developer can use it.

If the developer leaves for the day and decides to check in everything that he or she has checked out, he or she can do so by selecting his or her login ID along with the table or tables the objects reside on and check all the objects back in. This can be extremely crucial to some projects in which the development is a coordinated coding effort between the developers in different parts of the world, such as for example, a team of U.S. developers and Indian and/or Japanese developers.

Furthermore, these functionalities of the software development system or tool are embedded in the format control, forms designer, display option, display screen, and links of the software development tool. Thus, this software development system or tool increases quality and decreases the likelihood of rework.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for controlling code in a multi-developer software development environment, the method comprising:
identifying a plurality of software components as non-modifiable and preventing access and modification to the non-modifiable objects;
receiving a request from a requesting user to modify one of the software components;
determining whether the software component has been checked out by another user;
providing the requesting user with a modifiable copy of the one of the software component if the software component has not been checked out by another user.

2. The method as recited in claim 1, further comprising:
presenting the requesting user with an indication that the software component has been checked out by another user and is not available for modification if the object has been checked out by another user.

3. The method as recited in claim 1, further comprising:
creating a backup copy of the software component prior to providing the user with a modifiable copy of the software component.

4. The method as recited in claim 1, further comprising:
updating a file indicating that the software component is checked out, the identity of the user that checked out the software component, the date the software component was checked out, and the time the software component was checked out.

5. The method as recited in claim 1, further comprising:
prompting the requesting user to provide information about what is intended to be changed in the software component.

6. The method as recited in claim 5, further comprising:
updating a file indicating the changes intended to be made to the software component.

7. The method as recited in claim 1, wherein the software component is an object.

8. The method as recited in claim 4, wherein the file is one of a table and a database.

9. The method as recited in claim 6, wherein the file is one of a table and a database.

10. The method as recited in claim 2, further comprising:
determining whether the requesting user wishes to send a message to the user who currently has the object checked out;
prompting the requesting user to indicate the message to be sent to the user who currently has the software component checked out; and
sending the message to the user who currently has the software component checked out.

11. The method as recited in claim 10, further comprising:
determining the method the requesting user wished the message to be sent to the user who currently has the software component checked out; and
sending the message by the method specified by the requesting user.

12. The method as recited in claim 1, further comprising:
determining that the requesting user requests to check the software component back in;
prompting the requesting user to enter a description of what has changed to the software component; and
saving an updated software component, indicating that the software component is checked in, and indicating that the software component is not modifiable.

13. The method as recited in claim 12, further comprising:
updating a file indicating that the software component is checked back in, the date and time checked in, the identity of the developer who checked the software component back in, and the nature of the changes made to the software component.

14. A computer program product in a computer readable media for use in a data processing system for controlling code in a multi-developer software development environment, the computer program product comprising:
first instructions for identifying a plurality of software components as non-modifiable and preventing access and modification to the non-modifiable objects;
second instructions for receiving a request from a requesting user to modify one of the software components;
third instructions for determining whether the software component has been checked out by another user;
fourth instructions for providing the requesting user with a modifiable copy of the one of the software component if the software component has not been checked out by another user.

15. The computer program product as recited in claim 14, further comprising:
fifth instructions for presenting the requesting user with an indication that the software component has been checked out by another user and is not available for modification if the object has been checked out by another user.

16. The computer program product as recited in claim 14, further comprising:
fifth instructions for creating a backup copy of the software component prior to providing the user with a modifiable copy of the software component.

17. The computer program product as recited in claim 14, further comprising:
fifth instructions for updating a file indicating that the software component is checked out, the identity of the user that checked out the software component, the date the software component was checked out, and the time the software component was checked out.

18. The computer program product as recited in claim 14, further comprising:
fifth instructions for prompting the requesting user to provide information about what is intended to be changed in the software component.

19. The computer program product as recited in claim 18, further comprising:
sixth instructions for updating a file indicating the changes intended to be made to the software component.

20. The computer program product as recited in claim 14, wherein the software component is an object.

21. The computer program product as recited in claim 17, wherein the file is one of a table and a database.

22. The computer program product as recited in claim 19, wherein the file is one of a table and a database.

23. The computer program product as recited in claim 15, further comprising:
sixth instructions for determining whether the requesting user wishes to send a message to the user who currently has the object checked out;
seventh instructions for prompting the requesting user to indicate the message to be sent to the user who currently has the software component checked out; and
eighth instructions for sending the message to the user who currently has the software component checked out.

24. The computer program product as recited in claim 23, further comprising:
ninth instructions for determining the computer program product the requesting user wished the message to be sent to the user who currently has the software component checked out; and
tenth instructions for sending the message by the computer program product specified by the requesting user.

25. The computer program product as recited in claim 14, further comprising:
fifth instructions for determining that the requesting user requests to check the software component back in;
sixth instructions for prompting the requesting user to enter a description of what has changed to the software component; and
seventh instructions for saving an updated software component, indicating that the software component is checked in, and indicating that the software component is not modifiable.

26. The computer program product as recited in claim 25, further comprising:
eighth instructions for updating a file indicating that the software component is checked back in, the date and time checked in, the identity of the developer who checked the software component back in, and the nature of the changes made to the software component.

27. A system for controlling code in a multi-developer software development environment, the system comprising:
first means for identifying a plurality of software components as non-modifiable and preventing access and modification to the non-modifiable objects;
second means for receiving a request from a requesting user to modify one of the software components;
third means for determining whether the software component has been checked out by another user;
fourth means for providing the requesting user with a modifiable copy of the one of the software component if the software component has not been checked out by another user.

28. The system as recited in claim 27, further comprising:
fifth means for presenting the requesting user with an indication that the software component has been checked out by another user and is not available for modification if the object has been checked out by another user.

29. The system as recited in claim 27, further comprising:
fifth means for creating a backup copy of the software component prior to providing the user with a modifiable copy of the software component.

30. The system as recited in claim 27, further comprising:
fifth means for updating a file indicating that the software component is checked out, the identity of the user that checked out the software component, the date the software component was checked out, and the time the software component was checked out.

31. The system as recited in claim 27, further comprising:
fifth means for prompting the requesting user to provide information about what is intended to be changed in the software component.

32. The system as recited in claim 31, further comprising:
sixth means for updating a file indicating the changes intended to be made to the software component.

33. The system as recited in claim 27, wherein the software component is an object.

34. The system as recited in claim 30, wherein the file is one of a table and a database.

35. The system as recited in claim 32, wherein the file is one of a table and a database.

36. The system as recited in claim 28, further comprising:
sixth means for determining whether the requesting user wishes to send a message to the user who currently has the object checked out;
seventh means for prompting the requesting user to indicate the message to be sent to the user who currently has the software component checked out; and
eighth means for sending the message to the user who currently has the software component checked out.

37. The system as recited in claim 36, further comprising:
ninth means for determining the system the requesting user wished the message to be sent to the user who currently has the software component checked out; and
tenth means for sending the message by the system specified by the requesting user.

38. The system as recited in claim 27, further comprising:
fifth means for determining that the requesting user requests to check the software component back in;
sixth means for prompting the requesting user to enter a description of what has changed to the software component; and
seventh means for saving an updated software component, indicating that the software component is checked in, and indicating that the software component is not modifiable.

39. The system as recited in claim 38, further comprising:
eighth means for updating a file indicating that the software component is checked back in, the date and time checked in, the identity of the developer who checked the software component back in, and the nature of the changes made to the software component.
